(19) United States
(12) Patent Application Publication
(10) Pub. No.: US 2009/0121944 A1
(43) Pub. Date: May 14, 2009

(54) WIDEBAND ANTENNA

(75) Inventor: Omid SOTOUDEH, Upplands Vasby (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/936,975

(22) Filed: Nov. 8, 2007

(51) Int. Cl. H01Q 7/00; H01Q 1/24

(52) U.S. Cl. 343/702; 343/867

(57) ABSTRACT

The present invention relates to an antenna arrangement for a portable communication device as well as to such a portable communication device comprising such an antenna arrangement. The antenna arrangement includes at least one first loop antenna element provided in a loop structure. The loop structure includes at least one section shaped as a loop and each loop antenna element in the loop structure has only one connection point to be connected to a signal connection point of a radio circuit. The antenna arrangement also includes a planar antenna element for connection to a grounding connection point of the radio circuit. The loop structure is displaced from the planar antenna element in the plane in which this planar antenna element is provided.

### TECHNICAL FIELD OF THE INVENTION

The present invention relates to the field of antennas and more particularly to an antenna arrangement for a portable communication device as well as to a portable communication device having such an antenna arrangement.

### DESCRIPTION OF RELATED ART

Portable communication devices like mobile phones are increasingly becoming smaller and smaller.

At the same time it is of interest to provide antenna arrangements that have wideband properties in order to be able to function in various communication environments and using a variety of frequencies.

However, this is hard to achieve in a small-sized portable communication device.

It is generally known to provide solid disc shaped antennas that can be circular or elliptical. These have shown to have good wideband properties.

However it would be of interest to be able to use the antenna volume occupied by such an antenna element in a more efficient way in a portable communication device.

The present invention is directed towards providing such a possibility.

### SUMMARY OF THE INVENTION

The present invention is generally directed towards providing an antenna arrangement that is small, can be provided inside a portable communication device and which still has good antenna properties for a wide range of frequencies.

A first aspect of the present invention is directed towards an antenna arrangement for a portable communication device and including: at least one first loop antenna element provided in a loop structure, which loop structure includes at least one section shaped as a loop, where each loop antenna element in the loop structure has only one connection point to be connected to a signal connection point of a radio circuit, and a planar antenna element for connection to a grounding connection point of said radio circuit, where the loop structure is displaced from the planar antenna element in the plane in which the planar antenna element is provided.

A second aspect of the present invention is directed towards an antenna arrangement including the features of the first aspect, wherein the whole loop structure is provided in the same plane as or a plane parallel to the plane of the planar antenna element.

A third aspect of the present invention is directed towards an antenna arrangement including the features of the first aspect, wherein the whole loop structure is provided in a plane perpendicular to the plane of the planar antenna element.

A fourth aspect of the present invention is directed towards an antenna arrangement including the features of the first aspect, wherein the loop structure is provided on a curved surface.

A fifth aspect of the present invention is directed towards an antenna arrangement including the features of the fourth aspect, wherein the part of the loop structure closest to the planar antenna element in the plane of the planar antenna element and the part of the loop structure furthest from the planar antenna element in the plane of the planar antenna element are provided in a plane perpendicular to the plane of the planar antenna element.

A sixth aspect of the present invention is directed towards an antenna arrangement including the features of the first aspect, wherein the loop structure includes an inner loop section surrounded by an outer loop section.

A seventh aspect of the present invention is directed towards an antenna arrangement including the features of the sixth aspect, wherein the inner and outer loop sections are parts of the first loop antenna element and the outer loop section comprises the connection point and two opposing ends facing each other and separated by a gap, where each opposing end is joined to a corresponding opposing end of the inner loop section, where the two opposing ends of the inner loop section also face each other and are separated by a gap.

An eighth aspect of the present invention is directed towards an antenna arrangement including the features of the sixth aspect, wherein the inner loop section is made up of a second loop antenna element and the outer loop section is made up of the first loop antenna element.

A ninth aspect of the present invention is directed towards an antenna arrangement including the features of the eighth aspect, further comprising at least one intermediate loop section in the form of at least one further loop antenna element provided between the first and the second loop antenna elements.

A tenth aspect of the present invention is directed towards an antenna arrangement including the features of the sixth aspect, wherein the inner loop section is symmetrical to the outer loop section.

An eleventh aspect of the present invention is directed towards an antenna arrangement including the features of the sixth aspect, wherein the inner loop section is concentrically arranged in relation to the outer loop section.

A twelfth aspect of the present invention is directed towards an antenna arrangement including the features of the first aspect, wherein there is a free area in the centre of the loop structure.

A thirteenth aspect of the present invention is directed towards an antenna arrangement including the features of the first aspect, wherein each loop section is elliptical in shape.

A fourteenth aspect of the present invention is directed towards an antenna arrangement including the features of the first aspect, wherein each loop section is circular in shape.

A fifteenth aspect of the present invention is directed towards an antenna arrangement including the features of the first aspect, wherein each loop section is rectangular in shape.

A sixteenth aspect of the present invention is directed towards an antenna arrangement including the features of the first aspect, wherein the antenna arrangement is designed to be operating in a frequency range of 87 MHz to 10.7 GHZ.

A seventeenth aspect of the present invention is directed towards a portable communication device including: a radio circuit; at least one first loop antenna element provided in a loop structure, which loop structure includes at least one section shaped as a loop, where each loop antenna element has only one connection point connected to a signal connection point of the radio circuit; and a circuit board including a planar antenna element connected to a grounding connection point of the radio circuit, wherein the loop structure is displaced from the planar antenna element in the plane in which the planar antenna element is provided.

An eighteenth aspect of the present invention is directed towards a portable communication device including the features of the seventeenth aspect, wherein there is a free area in the centre of the loop structure.

A nineteenth aspect of the present invention is directed towards a portable communication device including the features of the eighteenth aspect, further including an electrically operated component provided in the free area.

A twentieth aspect of the present invention is directed towards a portable communication device including the features of the seventeenth aspect, wherein it is a mobile phone.

The invention has a number of advantages. It provides a small sized antenna arrangement that can be provided inside a portable communication device and still have good antenna properties for a wide range of frequencies. It furthermore allows the placing of electrically operated components within the loop structure. The invention is furthermore simple and can be produced at a low cost.

It should be emphasized that the term “comprises/comprising” when used in this specification is taken to specify the presence of stated features or components, but does not preclude the presence or addition of one or more other features, components or groups thereof.

### BRIEF DESCRIPTION OF THE DRAWINGS

The present invention will now be described in more detail in relation to the enclosed drawings, in which:

FIG. 1 shows a front view of a portable communication device according to the present invention,

FIG. 2 shows a front view of an antenna arrangement according to a first embodiment of the present invention connected to a radio circuit,

FIG. 3 shows a side view of the interior of the portable communication device including the antenna arrangement according to the first embodiment of the present invention,

FIG. 4 shows a side view of the antenna arrangement according to a variation of the first embodiment of the present invention,

FIG. 5 shows a side view of the antenna arrangement according to a second embodiment of the present invention,

FIG. 6 shows a side view of the antenna arrangement according to a third embodiment of the present invention,

FIG. 7 shows a front view of the antenna arrangement according to a fourth embodiment of the present invention, and

FIG. 8 shows a front view of the antenna arrangement according to a fifth embodiment of the present invention.

### DETAILED DESCRIPTION OF EMBODIMENTS

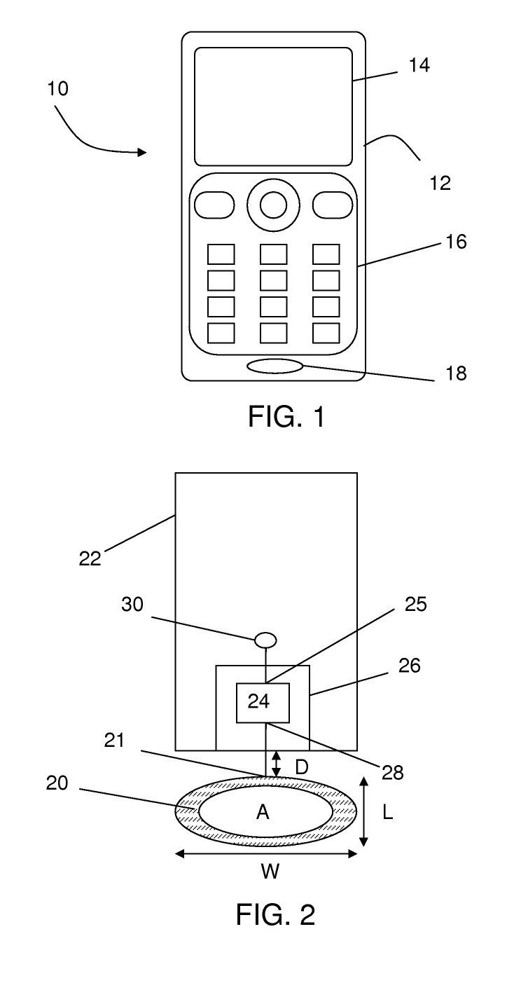

FIG. 1 shows a front view of a portable communication device 10 in the form of a mobile phone. The phone 10 has a casing 12, in the lower end of which there is provided a microphone 18 and a set of tactile user input units 16 in the form of a keypad. The phone 10 also includes a display 14 in an upper end of the casing 12. The other different functional units of the phone 10 are provided in the interior of the phone 10, i.e., inside the casing 12. The phone 10 furthermore comprises at least one antenna arrangement, which according to the invention is provided in the interior of the phone, i.e. inside the casing 12. The phone 10 may here include any of the functions normally provided in today's mobile phones, like for instance a music player, a camera, telephone and messaging functions. A phone is just one type of portable electronic device in which the present invention can be implemented. It may also be provided in devices such as laptop or palmtop computers or any other type of portable device that needs to communicate using one or more frequency ranges.

FIG. 2 shows a front view of an antenna arrangement according to first embodiment of the present invention being connected to a radio circuit 24. The antenna arrangement includes a first loop antenna element 20. The first loop antenna element 20 is provided in a loop structure, which loop structure includes at least one section shaped as a loop, which is here shaped substantially as an ellipse. In this embodiment the loop structure only includes one section, which is wholly made up of the first loop antenna element 20. The first loop antenna element 20, i.e. the section, thus here forms one full loop. The first loop antenna element has one and only one connection point 21 to a signal connection point 28 of the radio circuit 24. There is furthermore a planar antenna element 22 having a connection point 30 for connection to a grounding connection point 25 of the radio circuit 24. The planar antenna element 22 is here a ground plane for the antenna arrangement. Here the radio circuit 24 is shown as provided on the planar antenna element 22 and therefore it is provided via a substantially insulating island 26 in order to be separated from the ground plane 22. The radio circuit 24 is thus provided between the loop structure, here being made up of the first loop antenna element 20, and the ground plane 22. The loop structure and ground plane 22 here together function as an asymmetrical dipole antenna. The entire loop structure, here the entire first loop antenna element 20, is provided in the same plane as or a plane parallel to the ground plane 22 and distanced from the planar antenna element 22 a distance D within the plane in which this element 22 is provided. The part of the loop structure that has an extension W in the width dimension of the ground plane 22 is here aligned with the sides of the ground plane, i.e. it does not extend beyond these sides. In the first embodiment the major axis of the ellipse, is here aligned with the width of the ground plane. The loop structure may have dimensions L that vary in the length dimension of the ground plane 22. The loop structure also has a free area A in its center.

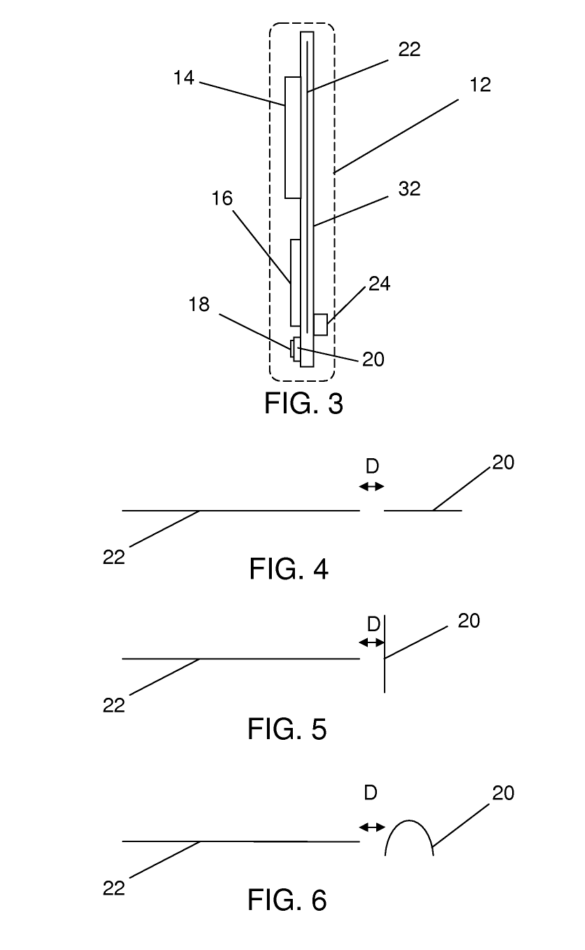

FIG. 3 shows a side view of the interior of the portable communication device including the antenna arrangement according to the first embodiment of the present invention. Inside the casing 12 there is a circuit board 32, in the middle of which the ground plane 22 is provided. On a first side of the board there are provided the display 14, keypad 16 and speaker 18 as well as the first loop antenna element 20. Here the speaker 18 is provided in the free area of the loop antenna element 20. On a second side of the board the radio circuit 24 is provided. It should here be realized that on what sides of the board the various units are provided is not central to the present invention. The board 32 and ground plane 22 stretch throughout most of the casing. However the board 32 may have a longer extension than the ground plane 22, since the ground plane 22 may not extend to the area where the loop antenna element 20 is provided. The loop structure is here provided in the lower end of the casing 12, which when a user holds the phone to his/her head, is intended to face downwards towards ground.

FIG. 4 shows a side view showing a variation of the first embodiment showing the relationship of the ground plane to the loop antenna element. As can be seen from this view the loop antenna element 20 is provided in the same plane as the ground plane 22. It may also as is shown in FIG. 3 be provided in a plane that is substantially parallel to the ground plane.

As has been mentioned earlier a solid elliptical element is known to have good wideband properties.

However, the surface currents of such an antenna element are mainly provided along the perimeter of the element. This means that it is possible to instead replace it with a loop, where the width of the element that forms the loop may have various widths. Such a replacement can be made without significantly reducing the good wideband properties. This furthermore allows electrically operated components to be placed in the free area. These components will not in any major way affect the antenna and the antenna will in no major way affect such a component. This is indicated in FIG. 3 through having the speaker provided in the free area of the first loop antenna element.

In the first embodiment it is possible to place the first loop antenna element at various distances D from the ground plane, where generally the further the loop antenna element is displaced from the ground plane, the bandwidth is decreased but the matching of the antenna is improved. For a ground plane having the dimensions 85×45 mm, for example, the distance D may range from about 2.5 to about 5 mm. An increase in the dimensions of the first loop antenna element may shift the band covered to lower frequencies. By making the free area smaller and thus increasing the width of the loop antenna element a lowering of the bandwidth may be obtained.

The above described first loop antenna element is just one way in which the antenna arrangement according to the present invention may be provided. As an alternative it is, according to a second embodiment of the present invention, possible to provide the entire first loop antenna element 20 in a plane substantially perpendicular to the ground plane 22. Such a situation is schematically shown in FIG. 5, which shows a side view of the antenna arrangement according to the second embodiment of the present invention. Here the performance of the antenna arrangement is not limited in any considerable way. A good wideband performance may here be obtained with the first loop antenna element only being provided at a distance of about 3 mm from the ground plane 22. This embodiment has the further advantage of limiting the extension of the antenna arrangement in the horizontal extension of the ground plane, i.e. horizontally in relation to the ground plane.

As yet another alternative, exemplified by a third embodiment of the present invention and shown in a side view of the antennal arrangement in FIG. 6, the first the loop antenna element 20 may be provided on a curved surface. This curved surface may be provided in the form of a flex film. Here the part of the loop antenna element 20 that is nearest to the planar antenna element 22 in the plane of this planar antenna element 22 and the part of the loop antenna element furthest from the planar antenna element in the plane of this planar antenna element 22 are provided in a plane substantially perpendicular to this plane of the planar antenna element 22. This also allows size limitations and allows the loop structure to adapted to the location in the interior of the phone where this loop structure is to be provided.

To improve operation of the antenna arrangement for some situations a second loop antenna element may be provided or the first loop antenna element may be bent in such a way that two loops are essentially provided.

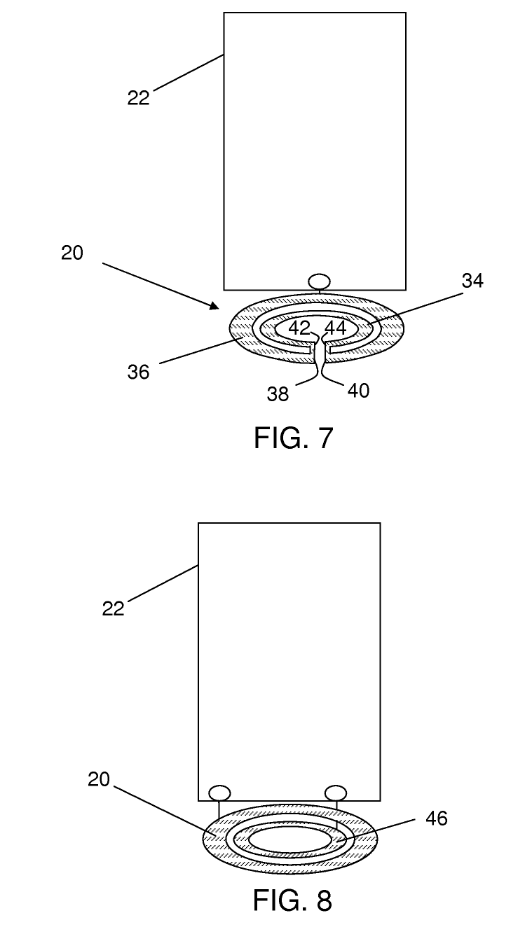

Such a bending of the first loop antenna element is shown in FIG. 7, which shows a front view of the antenna arrangement according to a fourth embodiment of the present invention. Also here the first loop antenna element 20 makes one full loop. However, here the loop structure is made up of two loop sections, an inner loop section 34 forming an inner loop and an outer loop section 36 forming an outer loop. The inner and outer loop sections 34 and 36 are here both parts of the first loop antenna element 20 and the outer loop section 36 comprises the connection point to the radio circuit and two opposing ends 38, 40 facing each other and separated by a gap, where each opposing end 38, 40 is joined to a corresponding opposing end 42 and 44 of the inner loop section 34, where the two opposing ends 42 and 44 of the inner loop section 34 also face each other and are separated by a gap. Here the inner loop section 34 is substantially symmetrical to the outer loop section 36 and also substantially concentrically arranged in relation to the outer loop section 36. Each loop section here furthermore substantially has the shape of an ellipse.

This way of providing the first loop antenna element provides two sections that have good antenna properties for two separate bands, where the outer section provides a lower band and the inner a higher band. The structure furthermore provides a stop band between the bands of the sections. This reduces external filtering that may otherwise be needed between the two bands. The two antenna sections may also be used for obtaining antenna diversity.

The provision of a second loop antenna element is shown in FIG. 8, which shows a front view of the antenna arrangement according to a fifth embodiment of the present invention. Here the loop structure includes an inner and an outer loop section, as in the fourth embodiment. However, each loop section here forms a full loop. Here the outer loop section is formed by the first loop antenna element 20, while the inner loop section is formed by the second loop antenna element 46, each being provided with its own connection point to the radio circuit. As in the fourth embodiment, the inner loop section is substantially symmetrical to the outer loop section and also substantially concentrically arranged in relation to the outer loop section. Each loop section also here has substantially the shape of an ellipse. Here it is also possible to provide a switch, which switches between operating of the loop antenna elements in order to switch in different frequencies. In all other respects the fifth embodiment has the same advantages as the fourth embodiment.

It is furthermore possible to vary this fifth embodiment through providing one or more intermediate loop sections in the form of one or more further loop antenna element provided between the first and the second loop antenna elements, where each such loop antenna element would have its own connection to the radio circuit.

It should here also be mentioned that the fourth and fifth embodiments may be varied along the lines mentioned in relation to the second and third embodiments.

The present invention has a number of advantages. It provides a small sized antenna arrangement that can be provided inside a portable communication device and still have good antenna properties for a wide range of frequencies. The various embodiments of the present invention thus cover a great variety of frequency bands, like GSM, UMTS, DVB-H, FM, and UWB bands. Thus it may be used between about 87 MHz and about 10.6 GHz. The invention furthermore allows the placing of electrically operated components within the loop structure, which allows further size reductions of the portable communication device. The invention is furthermore noncomplex and can be produced at a low cost.

The loops formed by the various sections were above described as being substantially elliptical. It should however be realised that loop structures may instead be substantially circular, substantially rectangular or of any other suitable loop shape. Therefore the present invention is only to be limited by the following claims.

What is claimed is:

1. An antenna arrangement for a portable communication device, comprising:
at least one first loop antenna element provided in a loop structure, wherein the loop structure includes at least one section shaped as a loop, each loop antenna element in the loop structure having only one connection point to connect to a signal connection point of a radio circuit; and
a planar antenna element to connect to a grounding connection point of said radio circuit, wherein the loop structure is displaced from the planar antenna element in the plane in which said planar antenna element is provided.

2. The antenna arrangement of claim 1, wherein the loop structure is provided in a same plane as or a plane parallel to the plane of the planar antenna element.

3. The antenna arrangement of claim 1, wherein the loop structure is provided in a plane perpendicular to the plane of the planar antenna element.

4. The antenna arrangement of claim 1, wherein the loop structure is provided on a curved surface.

5. The antenna arrangement of claim 4, wherein a part of the loop structure that is nearest to the planar antenna element in the plane of the planar antenna element and a part of the loop structure that is furthest from the planar antenna element in the plane of the planar antenna element are provided in a plane perpendicular to the plane of the planar antenna element.

6. The antenna arrangement of claim 1, wherein said loop structure includes an inner loop section surrounded by an outer loop section.

7. The antenna arrangement of claim 6, wherein the inner and outer loop sections are parts of the first loop antenna element and the outer loop section comprises said connection point and two opposing ends facing each other and separated by a gap, where each opposing end is joined to a corresponding opposing end of the inner loop section, where the two opposing ends of the inner loop section also face each other and are separated by a gap.

8. The antenna arrangement of claim 6, wherein the inner loop section is made up of a second loop antenna element and the outer loop section is made up of the first loop antenna element.

9. The antenna arrangement of claim 8, further comprising at least one intermediate loop section formed from at least one further loop antenna element provided between the first and the second loop antenna elements.

10. The antenna arrangement of claim 6, wherein the inner loop section is substantially symmetrical to the outer loop section.

11. The antenna arrangement of claim 6, wherein the inner loop section is substantially concentrically arranged in relation to the outer loop section.

12. The antenna arrangement of claim 1, wherein a free area exists in a center of the loop structure.

13. The antenna arrangement of claim 1, wherein each loop section is substantially elliptical in shape.

14. The antenna arrangement of claim 1, wherein each loop section is substantially circular in shape.

15. The antenna arrangement of claim 1, wherein each loop section is substantially rectangular in shape.

16. The antenna arrangement of claim 1, wherein the antenna arrangement operable in a frequency range of from about 87 MHz to about 10.7 GHz.

17. A portable communication device comprising:
a radio circuit;
at least one first loop antenna element provided in a loop structure, wherein the loop structure includes at least one section shaped as a loop, each loop antenna element having only one connection point to connect to a signal connection point of said radio circuit; and
a circuit board including a planar antenna element connected to a grounding connection point of said radio circuit, wherein the loop structure is displaced from the planar antenna element in the plane in which said planar antenna element is provided.

18. The portable communication device of claim 17, wherein a free area exists in a center of the loop structure.

19. The portable communication device of claim 18, further including an electrically operated component provided in the free area.

20. The portable communication device of claim 17, wherein the portable communication device is a mobile phone.
